(19) United States
(12) Patent Application Publication
(10) Pub. No.: US 2003/0128829 A1
(43) Pub. Date: Jul. 10, 2003

(54) Communication and vending refund center

(76) Inventor: Robert W. Hallman, Bensonville, IL (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/039,261

(22) Filed: Jan. 4, 2002

(51) Int. Cl. H04M 17/00

(52) U.S. Cl. 379/153; 379/144.03; 379/144.06; 379/145; 379/146; 379/149; 379/150

(57) ABSTRACT

A communication and refund center comprises a lockable cabinet structure having an access panel disposed on the cabinet structure cooperating to form a sealed enclosure when the access panel is engaged with the cabinet, a power supply to the interior of the cabinet, a coin chute accessible from the exterior of the cabinet structure, a coin magazine comprising a coin sleeve and a remotely actuated coin solenoid disposed above the coin chute, a telephone dialer, a digital voice modulator connected with and operative in response to the telephone dialer, a relay circuit operatively associated with the voice modulator and the coin solenoid, the relay circuit operating the coin solenoid in response to commands from the voice modulator to provide a specified number of coins to the coin chute. A modular mounting plate carries the power supply, telephone dialer, and voice modulator.

The present invention relates to a self-contained communication and vending refund center to be used in conjunction or combination with vending machines to provide a refund in the event of venting machine malfunction. More particularly, the apparatus of the present invention is directed to a self-contained refund center that provides for consumer communication to a service provider in the event of a vending machine malfunction and remotely activated refunding to immediately provide a refund to the consumer, thereby promoting consumer satisfaction and saving the vending machines from abuse, which is itself readily serviceable.

### BACKGROUND OF THE INVENTION

Vending machines are widely used in modern life. Vending machines, generally described, are machines that contain and display articles for sale, typically food and beverage products that may be purchased by a consumer without the need for a sales person or operator. In the industry of vending machine sales, it is typical that a single operator will maintain a number of different sites, each of themselves containing a number of different vending machines. The operator will then employ a number of individuals to go out and service the vending machines, that is, to replenish the sold products and to collect the money deposited in the automatic dispensing mechanisms.

Not infrequently, the vending machines malfunction and/or fail to deliver the requested goods after the customer has deposited money in the dispensing mechanism. In the past, it has been necessary for the customer to call a remote location and post a complaint and, more often than not, fail to receive a refund for the malfunctioning machine. Alternatively, the customer may attempt to jiggle or jostle the machine in an effort to dislodge, for example, a stuck product, or in fact physically assault the machine out of frustration. Under these circumstances, a vending machine can become broken and damaged, which creates additional cost and expense for the vending machine operator.

Also, the locations at which the vending machines are provided, such as hotels, gas stations, or other businesses are typically contacted by the customer in the event of vending machine malfunction. If these contacts of unsatisfied customers become sufficiently serious, the business operator may elect to replace the vending machine operator with another vending machine operator, whereby the first vending machine operator would lose the account.

Also, in the case of refrigerated machines for refrigerated foods, such as ice cream, a malfunction in the cooling device can create significant spoilage and loss of profitability from the vending machine. Moreover, the machine itself may be compromised by significant food spoiled therein. Finally, vending machines are commonly the targets of theft, as they are typically unmanned, whereby criminals either steel food and/or money out of the machines after breaking them open. Obviously, this creates damage to the machines and can create a significant source of loss for the vending machine operator.

Thus, a vending machine refund system is desired that will provide communication to the vending machine operator of malfunctions, vandalism, and/or failure of the vending machine, so that remedial action can be taken. It is also desired that the vending machine refund center be capable of providing an immediate and accurate refund to the customer to avoid a damaging relationship between the vending machine operator and the business operator at which the vending machines may be situated.

Other devices have been developed for providing a communication and vending refund center. However, these machines tended to be difficult and cumbersome to service in the field. Particularly, the wiring and componentry were separately mounted and interconnected, requiring significant time and effort to replace any singular piece and/or troubleshoot the component causing the fault condition. Thus, an improved machine design and method of servicing the aforementioned machines was required.

### SUMMARY OF THE INVENTION

The aforementioned drawbacks and shortcomings of the prior art are elegantly solved with the communication and refund center of the present invention, which provides a self-contained system for recording an identifying message and subsequent playback of the message. The system comprises a lockable cabinet structure having an access panel disposed on the cabinet structure, the access panel and cabinet structure cooperating to form a sealed enclosure when the access panel is engaged with the cabinet, a power supply to the interior of the cabinet, a coin chute accessible from the exterior of the cabinet structure, a coin magazine comprising a coin sleeve and a remotely actuated coin solenoid disposed above said coin chute, a telephone dialer operatively connected to an outside line, a digital voice modulator connected with and operative in response to said telephone dialer, a relay circuit operatively associated with said voice modulator and said coin solenoid, said relay circuit operating said coin solenoid in response to commands from said voice modulator to provide a specified number of coins to said coin chute, and a modular mounting plate disposed within the sealed enclosure, the modular mounting plate carrying said power supply, telephone dialer, and voice modulator.

Thus, a machine is provided that accurately provides information to the vending machine operator at the time of the occurrence of the problem, not after the fact. The vending machine operator, or his agent, is contacted directly, not the business operator at which the machines are disposed. Customer satisfaction is increased in the sense that the customer is able to explain his problem directly to the vending machine operator or his agent. Machine abuse is avoided and business operator relations are promoted.

Also, an alert can be provided to the vending machine operator, where a problem can be immediately called into the vending machine operator or his agent. This can include open machine doors, which reduces the possibility of theft, and failure of primarily refrigeration units to continue to operate properly. Troubleshooting time is reduced and made more efficient. Moreover, the communication and vending refund system of the present invention can be used to check when the route person is at locations and provide better accountability for employee performance.

Other objects, advantages and features of the invention will become apparent upon a consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosure that will be described hereinafter which will form the subject matter of the claims appended hereto.

In this respect, before explaining the preferred embodiment of the disclosure in detail, it is to be understood that the disclosure is not limited in its application to the details of the construction and the arrangements set forth in the following description or illustrated in the drawings. The refund center of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the appended claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U.S. Patent and Trademark Office and the public generally, and especially the scientists, engineers and practitioners in the art who are not familiar with the patent or legal terms of phraseology, to learn quickly from a cursory inspection the nature and essence of the technical disclosure of the application. Accordingly, the Abstract is intended to define neither the invention nor the application, which is only measured by the claims, nor is it intended to be limiting as to the scope of the invention in any way.

These and other objects, along with the various features and structures that characterize the invention, are pointed out with particularity in the claims annexed to and forming a part of this disclosure. For a better understanding of the identification system of the present disclosure, its advantages and the specific objects attained by its uses, reference should be had to the accompanying drawings and descriptive matter in which there are illustrated and described the preferred embodiments of the invention.

While embodiments of the identification system are herein illustrated and described, it is to be appreciated that various changes, rearrangements and modifications may be made therein, without departing from the scope of the invention as defined by the appended claims.

### BRIEF DESCRIPTION OF THE DRAWINGS

FIG. 1 is a perspective view of the preferred embodiment of the self-contained communication and vending refund center of the present invention in the closed, protected mode;

FIG. 2 is a perspective view of the preferred embodiment of the self-contained communication and vending refund center of the present invention in the open, service mode;

FIG. 3 is a sectional plan view of the rear wall of the preferred embodiment of the self-contained communication and vending refund center of the present invention with the front wall removed to expose the modular mounting plate and components carried therein;

FIG. 4 is a side cross-sectional view of the preferred embodiment of the self-contained communication and vending refund center of the present invention;

FIG. 5 is an overall schematic circuit diagram for the preferred embodiment of the self-contained communication and vending refund center of the present invention;

FIG. 6 is a detailed schematic circuit diagram for the call in progress indicator light for the preferred embodiment of the self-contained communication and vending refund center of the present invention; and

FIG. 7 is a detailed schematic circuit diagram for the call in progress indicator pay out counter for the preferred embodiment of the self-contained communication and vending refund center of the present invention.

### DETAILED DESCRIPTION OF PREFERRED EMBODIMENT

The best mode for carrying out the invention is presented in terms of the preferred embodiment, wherein similar reference characters designate corresponding features throughout the several figures of the drawings.

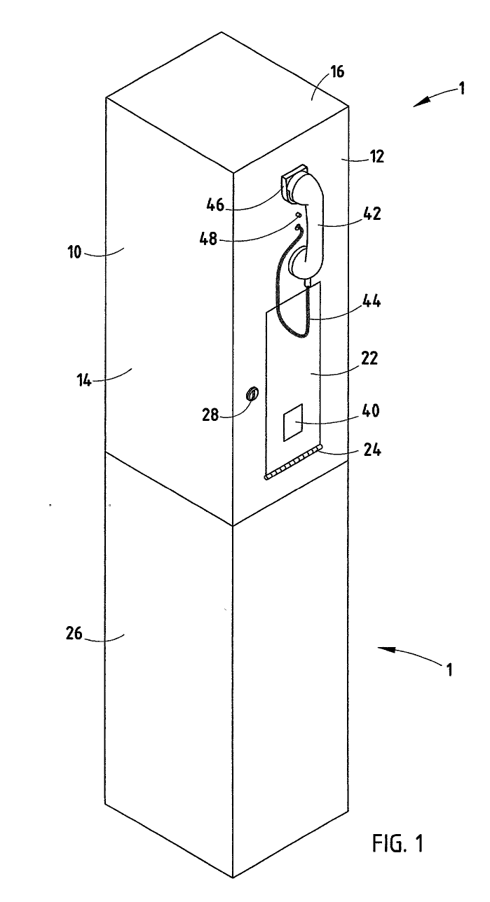

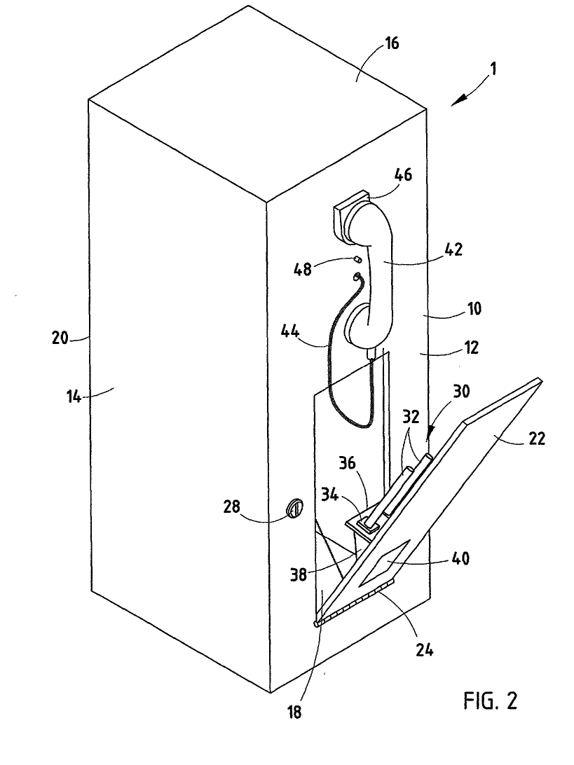

Referring now to the drawings, particularly FIG. 1, there is shown in perspective view the self-contained refund center 1 of the present invention. The center 1 consists primarily of a cabinet structure 10 having a front 12, sides 14, top 16, and bottom 18. As is known in the art, the sides 14 and front 12 can be formed separately from the top 16 and bottom 18, as well as a back 20, in separate pieces or in integrated stamp pieces, as is desired. In the preferred mode, the cabinet 10 is fully protected from and sealed against the environment. A front access panel 22 is hingedly attached to the front face 12 of the cabinet 10, preferably through piano hinge 24, as shown in FIG. 2. As shown, the cabinet 10 sits atop a support structure 26, as shown in FIG. 1, primarily for ease of use and service. However, there is no requirement that the unit have any particular height, other than that height which would allow it to be used by customers and service personnel. The cabinet is preferably made out of resistant steel for vandal resistance.

The access panel 22 is operated in conjunction with keyed-lock cylinder 28, as is typical in the trade. That is, rotation of box cylinder 28 allows panel 22 to pivot downwardly on hinge 24 to expose the interior of the cabinet 10.

Preferably, a coin magazine 30 is operatively disposed on the interior of the panel 22, as best seen in FIG. 4. The coin magazine 30 includes one or more coin sleeves 32, a coin solenoid 34 mounted atop a platform 36, which sits above, and is communication with, coin chute 38. The coin sleeve can preferably contain a combination of quarters and nickels sufficient to provide change to virtually any combination or amounts that typical vending machines might utilize. Preferably, the sleeves contain sufficient quarters and nickels, preferably up to a capacity of about $35 that would prevent excessive service, but yet provide little incentive for theft. However, it is contemplated that coin values of a dollar may be used advantageously, in accordance with the present invention.

A movable pivotal door 40 is provided in the access panel 22 into the coin chute 38. The pivotal door 40 is hinged at the top and is weighted so that it is urged into a closed position, as shown in FIG. 1.

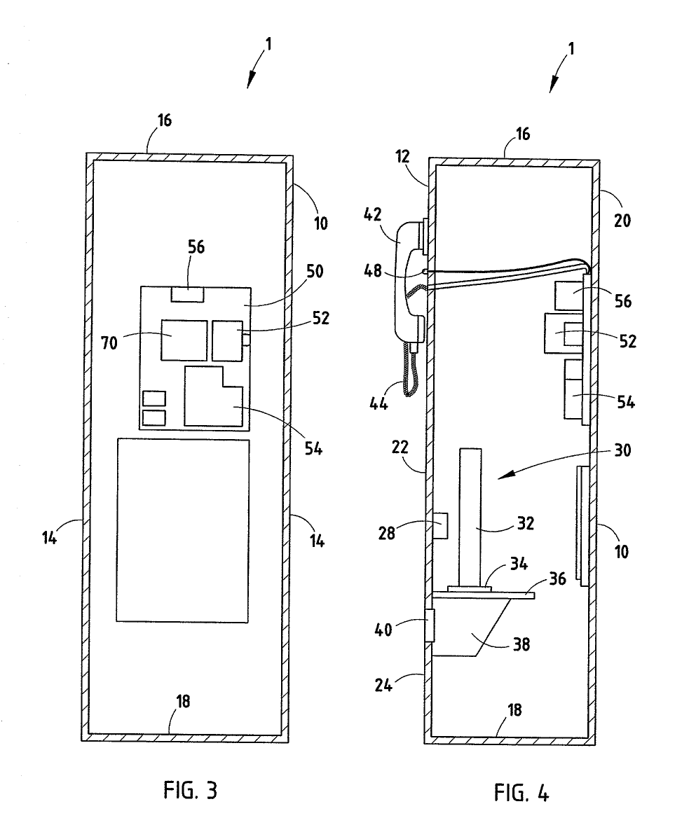

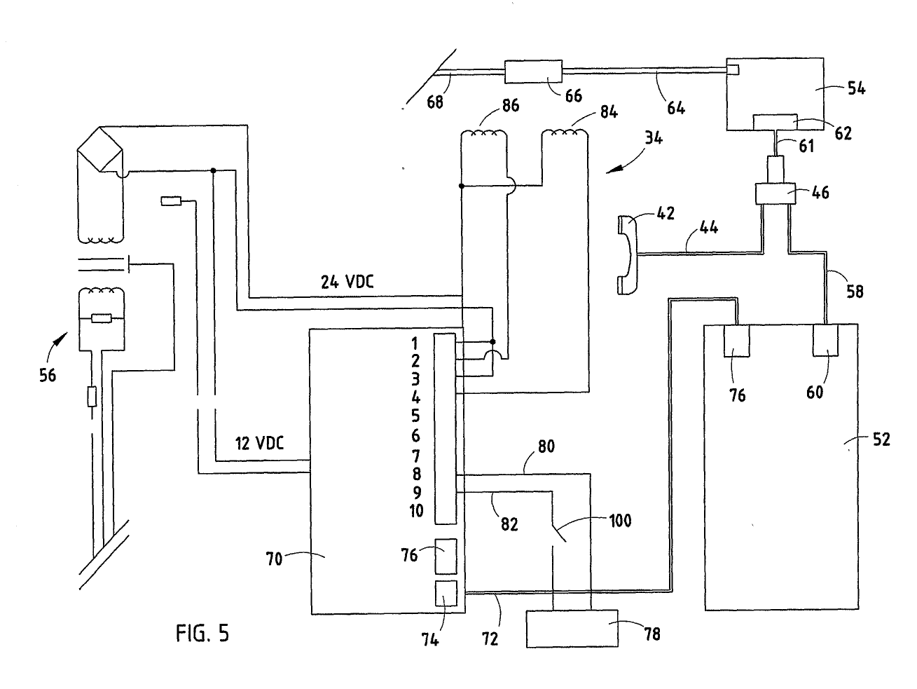

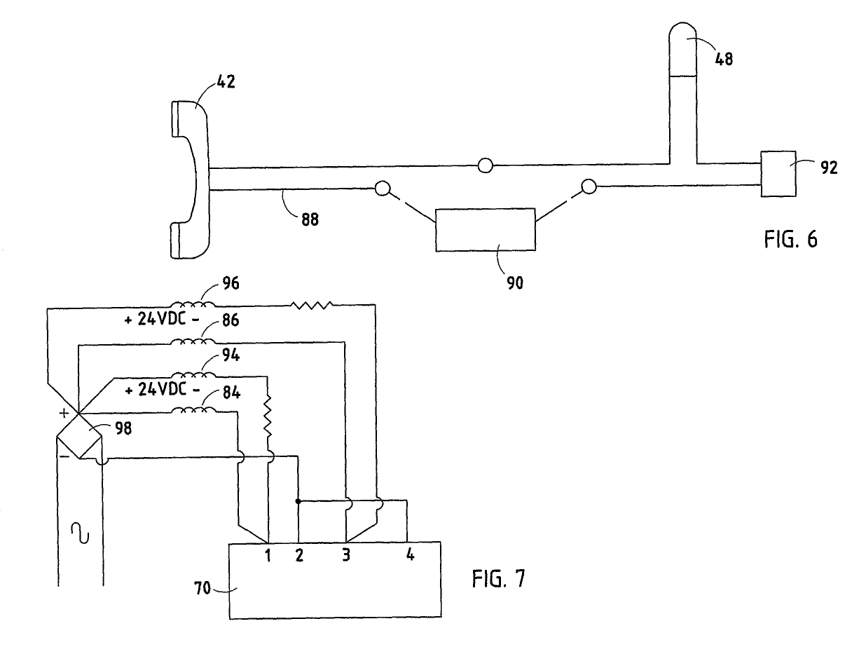

The center 1 is also provided with an interface device, preferably a telephone 42, as shown in FIGS. 1 and 2. The telephone 42 is connected by a cable 44 to a splitter 46, as best shown in the circuit diagram of FIG. 5. As set forth more fully below, the telephone may be used to allow the customer to contact the vending machine operator, or his agent, to report a failure to dispense goods or to return sufficient change through the use of paper currency in the machine. Lifting up the handset of telephone 42 from the handset receiver 46, as will be described in more detail below, automatically opens a telephone line and causes the voice modulator dialer to call the vending machine operator. An indicator light 48 preferably indicates that a line has been opened and that the system and center are working properly. This indicator light is better shown in FIG. 6. As shown in FIGS. 3 and 5, the device further includes a modular mounting plate 50 to which is attached voice modulator 52, dialer 54, and power supply 56. Power supply 56 preferably includes a transformer for taking 110 VAC and reducing the same to 24 VDC and 12 VDC.

As shown in FIG. 5, handset 42 communicates through cable 44 to a splitter 46. Splitter 46 provides a line in line 58 to line in port 60 of the voice modulator 52. Splitter 46 also communicates via phone line 61 to phone line in 62 of dialer 54. Phone line 64 communicates with junction FEM to FEM 66 to the phone line 68 to the general phone service. Of course, a cellular phone system can be used in place of the general phone service, where the dialer 54 accesses a cellular phone network directly. The dialer 54 operates to automatically dial the call to the vending machine operator simply upon picking up the handset 42 from the cradle 46. Preferably, the dialer 54 is provided a sequence of numbers to be called, in the event that any preceding number is out of service or a busy signal is encountered.

The system also provides communications from the voice modulator 52 to a relay unit 70, as provided by line 72. Relay unit 70 includes a convention RJ in and RJ outline, as shown at junctions 74 and 76, respectively. Line 72 communicates the RJ outline 74 to a RJ input 76 in the voice modulator 52. An alarm junction 78 is in communication by line 80 and 82 to points on the relay unit to provide an alarm input in the case of a vending machine malfunction. For example, the alarm could be generated by a door being opened on the vending machine without authorization, indicating a theft is occurring. Likewise, the alarm could indicate that power to the vending machine refrigeration unit has been interrupted and/or that there is a failure in the refrigeration unit, suggesting that service is necessary to the refrigeration unit to preserve the stock of food products housed within the vending machine. Likewise, the alarm junction can be used to indicate frequency of the machine being opened by the maintenance personnel of the vending machines to determine that their cycle rate is appropriate and to determine that no material, such as coin or product, is removed from the vending machine.

The relay unit 70, which is also preferably mounted to the modular mounting plate 50, is also connected to the coin solenoids 34, which respectively preferably include a nickel payout coil 84 and a quarter payout coil 86, which may be selectively actuated by the relay unit upon appropriate input signals from the vending equipment operator. With the line 64 and 68 open from the dialer, the operator can provide a signal to the voice modulator through the dialer 54, splitter 46 and to the voice modulator 52, through the relay unit 70, to indicate that a combination of coins should be dispensed from the coin sleeve 32 into the coin sleeve 38 for retrieval by the customer 40. For example, when a customer calls in, the handset is picked up, and the phone at the other end will automatically ring and a connection will be established when answered. Money can be refunded during the conversation by the operator entering a security code plus two digits for quarters and two digits for nickels. For example, for $0.25, during the conversation, the operator can enter 123456, 12 to dispense $0.25. To dispense $0.05, the operator can dial in 123456, 22. To refund $0.55 during the conversation, the operator can dial in 123456, 12, 12, 22, leaving a short pause between solenoid activations to allow the coin solenoids to return to the closed position. Finally, to retrieve $1.05 during the conversation, the operator can dial in 123456, 12, 12, 12, 12, 22. Preferably, the security code needs to be entered only once during each conversation and may be connected to a speed dial button on the operator's telephone to speed dial in various refund amounts. The auto dialer preferably uses touch-tone programmability in non-volatile memory, so that the information for the phone numbers is permanently stored, even during power outages. The telephone preferably hangs up automatically or times out after a preset period of silence, a busy signal, or no dial tone. As shown in FIG. 6, the handset 42 is connected via lines 84 to contacts 86 situated in the handset cradle 46 and is plugged into the relay unit 70 and made operative through line out 88, contact 90, and plug 92 to indicate that the phone line is open.

Further features of the invention are shown in FIG. 7, wherein a payout counter is shown, wherein the relay unit 70 further includes relay contacts 1, 2, 3, and 4, as also shown in FIG. 5. Payout coils 84 and 86 are situated in the circuit along with payout counter 94 and payout counter 96 for nickels and quarters, respectively. Payout counter operates to indicate the number of coins that have been dispensed into the coin chute 38, so that a proper tally can be made and a signal can be received by the system operator to know that proper change has been provided to the customer at the communication and refund center. Preferably, the solenoid and counters are powered by 24 VDC, coming from a transformer provided in the transformer 56 provided through a rectifier 98, which also provides 12 VDC to the relay unit itself, as shown.

Preferably, the key switch 100, as shown in FIG. 5, is provided between the junction of the alarm input and the relay unit 70, so that the system is not triggered when the key is used to open the access panel 22.

As a further feature of the present invention, a method for using the system includes readily replaceable components, as shown in FIGS. 3 and 4. For example, each of the voice modulator 52, dialer 54, and power supply 56 are attached to the modular mounting plate 50. In practice, should a fault occur in the refund center, such faults will more than likely occur in one of these three components. Rather than taking the time and incurring the expense to troubleshoot the refund center component by component, the entire modular mounting plate 50 can be removed, the individual components mounted thereon disconnected, and a substrate replacement modular mounting plate 50, with properly working components, installed therefore. The old, modular mounting plate 50 can be taken to a repair facility, where it can be tested and the offending component replaced. The repaired modular mounting plate can then be reinstalled the next time a fault in a refund center arises. Thus, as can be appreciated, repair cost and unit down time can be significantly reduced.

The solutions offered by the invention herein have thus been attained in an economical, practical, and facile manner. To wit, an effective and convenient self-contained refund center is disclosed. While preferred embodiments and example configurations of the invention have been herein illustrated, shown and described, it is to be appreciated that various changes, rearrangements and modifications may be made therein, without departing from the scope of the invention as defined by the appended claims. It is intended that the specific embodiments and configurations disclosed are illustrative of the preferred and best modes for practicing the invention, and should not be interpreted as limitations on the scope of the invention as defined by the appended claims and it is to be appreciated that various changes, rearrangements and modifications may be made therein, without departing from the scope of the invention as defined by the appended claims.

I claim the following:

1. A self-contained communication and vending refund center for use in association with one or more vending machines, the refund center comprising:
a cabinet structure;
a lockable access panel disposed on the cabinet structure, the access panel and cabinet structure cooperating to form a sealed enclosure when the access panel is engaged with the cabinet;
a coin chute accessible from the exterior of the cabinet structure;
a power supply;
a coin magazine comprising a coin sleeve and a remotely actuated coin solenoid disposed above said coin chute;
a telephone dialer operatively connected to a telephone service;
a digital voice modulator connected with and operative in response to said telephone dialer;
a relay circuit operatively associated with said voice modulator and said coin solenoid, said relay circuit operating said coin solenoid in response to commands from said voice modulator; and
a modular mounting plate disposed within the sealed enclosure, the modular mounting plate carrying said power supply, telephone dialer, and voice modulator.

2. The self-contained communication and vending refund center of claim 1, wherein the refund center further comprises an alarm system, the alarm system comprising a switch operatively connected with the digital voice modulator, said switch being responsive to said vending machine to generate a fault signal, whereby said voice modulator responds to said fault signal to telephone a vending machine operator.

3. The self-contained communication and vending refund center of claim 1, wherein the telephone dialer operates a cellular telephone network.

4. The self-contained communication and vending refund center of claim 1 further comprising a transformer and surge protector, said transformer mounted to said modular mounting plate.

5. The self-contained communication and vending refund center of claim 1, wherein the telephone dialer is connected to a handset resting in a cradle mounted on the exterior of the cabinet, wherein activation of the dialer is automatically obtained by lifting the handset from the cradle.

6. The self-contained communication and vending refund center of claim 1, further comprising an indicator lamp for signaling activation of the telephone dialer therein.

7. The self-contained communication and vending refund center of claim 1, wherein said refund center further comprises a pay out counter, said pay out counter in selective communication with the relay circuit for monitoring the number of coins deposited into the coin chute.

8. The self-contained communication and vending refund center of claim 1, wherein said modular mounting plate is mounted on a rear wall of said cabinet.

9. The self-contained communication and vending refund center of claim 1, wherein said relay circuit is mounted on a rear wall of said cabinet.

10. A system for providing a refund to customer self-contained communication and vending refund center for use in association with one or more vending machines, the refund center comprising a lockable a cabinet structure having an access panel disposed on the cabinet structure, the access panel and cabinet structure cooperating to form a sealed enclosure when the access panel is engaged with the cabinet, a power supply to the interior of the cabinet, a coin chute accessible from the exterior of the cabinet structure, a coin magazine comprising a coin sleeve and a remotely actuated coin solenoid disposed above said coin chute, a telephone dialer operatively connected to a telephone network, a digital voice modulator connected with and operative in response to said telephone dialer, a relay circuit operatively associated with said voice modulator and said coin solenoid, said relay circuit operating said coin solenoid in response to commands from said voice modulator to provide a specified number of coins to said coin chute, and a modular mounting plate disposed within the sealed enclosure, the modular mounting plate carrying said power supply, relay circuit telephone dialer, and voice modulator.

11. The self-contained communication and vending refund center of claim 10, wherein an alarm cooperates with a key switch connected to the relay circuit for providing an alarm signal to the digital voice modulator.

12. The self-contained communication and vending refund center of claim 11, further comprising an indicator lamp for signaling activation of the telephone therein.

13. The self-contained communication and vending refund center of claim 11, wherein the telephone dialer operates a cellular telephone network.

14. The self-contained communication and vending refund center of claim 11 further comprising a transformer and surge protector, said transformer mounted to said modular mounting plate.

15. The self-contained communication and vending refund center of claim 11, wherein the telephone dialer is connected to a handset resting in a cradle mounted on the exterior of the cabinet, wherein activation of the dialer is automatically obtained by lifting the handset from the cradle.

16. The self-contained communication and vending refund center of claim 1, further comprising an indicator lamp for signaling activation of the telephone dialer therein.

17. The self-contained communication and vending refund center of claim 1, wherein said refund center further comprises a pay out counter, said pay out counter being in selective communication with the relay circuit for monitoring the number of coins deposited into the coin chute.

18. The self-contained communication and vending refund center of claim 1, wherein said modular mounting plate is mounted on a rear wall of said cabinet.

19. The self-contained communication and vending refund center of claim 1, wherein said relay circuit is mounted on a rear wall of said cabinet.

20. A method for providing a refund to customer, the method comprising:
fabricating a lockable cabinet structure having an access panel disposed on the cabinet structure, the access panel and cabinet structure cooperating to form a sealed enclosure when the access panel is engaged with the cabinet;
providing a power supply to the interior of the cabinet;
mounting a coin chute accessible from the exterior of the cabinet structure;
mounting a coin magazine comprising a coin sleeve and a remotely actuated coin solenoid disposed above said coin chute to said access panel;
attaching a telephone dialer operatively connected to a telephone network, and a digital voice modulator connected with and operative in response to said telephone dialer to a modular mounting plate disposed within the sealed enclosure, the modular mounting plate carrying said power supply, telephone dialer, and voice modulator; and
installing a relay circuit operatively associated with said voice modulator and said coin solenoid, said relay circuit operating said coin solenoid in response to commands from said voice modulator to provide a specified number of coins to said coin chute.

21. The method for providing a refund of claim 20, further comprising the step of mounting said power supply to said modular mounting plate disposed on the interior of the cabinet, and providing an alarm that cooperates with a key switch connected to the relay circuit for providing an alarm signal to the digital voice modulator.
